(19) United States
(12) Patent Application Publication
(10) Pub. No.: US 2026/0252346 A1
(43) Pub. Date: Aug. 27, 2026

(54) ADJUDICATION FOR A BUILD ORCHESTRATION SYSTEM

(71) Applicant: Palantir Technologies Inc., Denver, CO (US)

(72) Inventors: Ted Chester Jenks, New York, NY (US); John Ayad, London (GB); Lorenzo Martini, London (GB)

(21) Appl. No.: 19/189,929

(22) Filed: Apr. 25, 2025

Related U.S. Application Data
(60) Provisional application No. 63/762,307, filed on Feb. 24, 2025.

(51) Int. Cl. G06F 8/71; G06F 8/65; G06F 11/3604

(52) U.S. Cl. CPC G06F 8/71; G06F 8/65; G06F 11/3612

(57) ABSTRACT

A computing system can facilitate adjudication of updates to one or more job specifications for executing one or more tasks associated with a data processing workflow. The system can be configured to input one or more job specifications, such as originating from a build orchestration system, and one or more rules to generate an upgrade specification and a safest specification. The system can be configured to cause execution of the upgrade specification. The system can determine whether execution of the upgrade specification is successful. If execution of the upgrade specification is successful, the system can be configured to record one or more datasets generated via execution of the upgrade specification. If execution of the upgrade specification is not successful, the system may be configured to cause execution of the safest specification. The system may record one or more datasets generated via execution of the safest specification.

### CROSS-REFERENCE TO RELATED APPLICATIONS

This application claims benefit of U.S. Provisional Patent Application No. 63/762307, filed February 24, 2025, and titled “ADJUDICATION FOR A BUILD ORCHESTRATION SYSTEM.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

Implementations of the present disclosure relate to systems and techniques for improving updates to data processing workflows. More specifically, implementations of the present disclosure relate to computerized systems and techniques that improve adjudication of updates to data processing workflows, among various other functionalities, in computing environments.

### BACKGROUND

Computerized systems manage and execute various different computational workflows. These systems can leverage frameworks to provide a standardized way in which computational workflows are managed and executed to facilitate seamless data transformations and scalable processing.

### SUMMARY

The systems, methods, and devices described herein each have several aspects, no single one of which is solely responsible for its desirable attributes. Without limiting the scope of this disclosure, several non-limiting features will now be described briefly.

Updating data processing workflows can present difficulties with existing techniques and systems. For example, when developers push an update associated with a data processing workflow, the update may break said data processing workflow, such as by introducing bugs and/or security vulnerabilities. This may be particularly true when developers push updates relating to data processing workflows where the workflows incorporate user-authored code. For example, a user may have modified their code, such as by removing functions, changing a number of arguments taken in by a function, and/or the like. In such instances, the update may be incompatible with code stored in the user’s code repository, and may cause unexpected behavior due to dependency conflicts, schema changes, execution environment issues, logical errors, input/output misconfigurations, and/or the like.

The present disclosure includes a computing system that can advantageously adjudicate updates to one or more portions of one or more data processing workflows without reducing (or while mitigating reduction of) system performance. The system can generate one or more job specifications, such as an upgrade specification associated with updating a data processing workflow and a safest specification associated with historically successful executions of the data processing workflow, as further described herein. The system can test the upgrade specification to ensure that the upgrade specification will not fail an execution of the data processing workflow. If the test indicates that the upgrade specification will fail an execution of the data processing workflow, the system may implement and consume the safest specification. In this way, the system can advantageously ensure that after an update is pushed, subsequent executions of a data processing workflow will not fail by way of the update as either the system will implement and consume an upgrade specification that has satisfied adjudication or implement and consume a safest specification that is known to be issue-free.

Various combinations of the above and below recited features, embodiments, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums or devices comprising, configured to store, and/or storing program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums or devices, and/or one or more computer-readable storage mediums or devices, are disclosed, wherein the computer-readable storage mediums comprise, are configured to store, and/or store program instructions, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings.

FIG. 1A is a block diagram illustrating an example operating environment including a build orchestration system, according to various implementations of the present disclosure.

FIG. 1B is a block diagram illustrating interactions among components of a build orchestration system and computing module for adjudicating updates to data processing workflows, according to various implementations of the present disclosure.

FIG. 2 is a block diagram illustrating data interactions among components of a computing module for adjudicating updates to data processing workflows, according to various implementations of the present disclosure.

FIGS. 3A-3B illustrate example graphical user interfaces associated with adjudicating updates to data processing workflows, according to various implementations of the present disclosure.

FIGS. 4A-4H are flow diagrams illustrating example processes associated with adjudicating updates to data processing workflows, according to various implementations of the present disclosure.

FIG. 5 is a block diagram of an example computer system useable with the various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein

### Overview

A “build” refers to a computational mechanism for computing new versions of datasets. In this way, a build can be a process of executing a transformation or computation to produce an updated version of a dataset or data pipeline output. Builds provide orchestration and coordination of computation, ensuring that appropriate input data is read and that output data is written to an appropriate location. A build may be associated with a data processing workflow. In this context, a “data processing workflow” is inclusive of data moving through various processing stages (e.g., ingestion, cleaning, transformation, analysis, and/or the like) until the data reaches a final usable state.

A build is composed of one or more “jobs,” each of which are a unit of work that is defined by shared logic. Each job computes one or more output datasets. In this way, each job can be representative of an executable task that is performed when executing a build. Jobs may depend on one another. For example, a set of output data generated by Job A may subsequently be used by Job B to produce another set of different output data. For example, in a flight tracker analysis pipeline, Job A may compute a set of output data representative of flight tracker data, and Job B may subsequently compute a set of output data representative of flight delays based on inputted flight tracker data. In some cases, jobs may not be dependent on each other (e.g., one job does not use output data generated by another job), in which case said jobs may be executed in parallel.

A job specification defines how to construct a job. The job specification may be stored as any available type of text file. The job specification can include information relating to various runtime parameters and associated logic that should be executed as part of a job. In some embodiments, runtime parameters can include one or more of: input data configurations; output data configuration; job metadata (e.g., job name, job type, job version, and/or the like); execution environment; runtime dependencies; and/or the like. Input data configurations can include an input data source, input data dependencies, input data schema, input data formatting, and/or the like. Output data configurations can include storage location(s) for output data, output data schema, output data formatting, output data compressions, output data partitioning, output data overwrite behavior, and/or the like. Execution environments can include any available type of computerized environment in which code can execute, such as but not limited to, browsers, operating systems, virtual machines, hypervisors, container and containerization platforms, cloud-based and/or cloud-like environments, edge computing environments, cross-platform runtime environments, other shared and distributed systems, and/or the like. Runtime dependencies can include executable code (e.g., scripts), libraries, Java Archive files (JARs), other computing modules, and/or the like that provide functionality for a job. Executable code associated with one or more APIs may be bundled within an executable of the dependency. The dependencies can include the actual logic (e.g., transformation logic, analysis logic, and/or the like) of the job. A job specification associated with an SQL transformation job for a flight tracker analysis build, for example, may include information indicative of the following runtime parameters: an input dataset such as raw flight GPS data, a runtime dependency having the SQL logic, an output dataset such as a flight delay summary, and an execution environment for executing the SQL logic.

Builds can execute on a recurring basis automatically and/or manually. Builds may execute on a recurring basis according to a schedule. The schedule may include a trigger that defines a condition that, when satisfied, causes an associated build to execute. In some embodiments, the entire build may execute, or one or more portions of the build may execute. In some embodiments, the trigger can cause an associated build to execute at a certain time of day. In some embodiments, the trigger cause an associated build to execute when certain data is updated or modified, such as input data that is processed by the build. For example, updates or modification to raw weather data may trigger a flight tracker analysis build to execute and process the updated and/or modified raw weather data to output a new set of flight delay data. In some embodiments, the trigger can cause an associated build to execute when associated logic implemented and consumed by the build has been updated or modified (e.g., a job specification has been updated or modified).

To help ensure that runtime environments operate free of bugs and/or security vulnerabilities, developers commonly have contractual obligations to push updates (e.g., updates to source code, libraries, and/or other executables) that fix these identified issues. In some cases, developers may push an update that includes updated job specifications to correspondingly update one or more jobs of a build. For example, a job may need to input a different input dataset, execute in a different execution environment, implement and consume different logic (e.g., via different runtime dependencies), and/or the like, which can be described in the updated job specification. However, these updates can sometimes break builds due to incompatibilities and/or unexpected behavior changes such as may be caused by dependency conflicts, schema changes, execution environment issues, logical errors, input/output misconfigurations, and/or the like. For example, a user may have altered code in their code repository (e.g., removed a function, changed a number of arguments taken in by a function, and/or the like), which can conflict with the updated job specifications. This can be especially problematic for builds that are scheduled to automatically run. Consequently, developers may have to roll back updates to previous versions and/or push hotfixes, thereby delaying deployment of successful updates.

To avoid introducing breaks in builds such as may be caused by updating one or more job specifications, developers typically use phased rollouts (e.g., gradual deployment), beta releases, and/or hotfixes and emergency patches. However, these update techniques cause compute inefficiencies. For example, phased deployments can increase processing needs and/or storage requirements due to maintaining multiple active versions of different job specifications. Beta testing can increase computing overhead and/or loads to deliver updates to beta testers and to support multiple active versions of job specifications across the system. Hotfixes and/or emergency patches can introduce compute inefficiencies resulting from rushed deployments where computational resource management is an afterthought compared to mitigating customer irritation.

Advantageously, systems, methods, and associated functionality (generally referred to herein as the system) can adjudicate updates to job specifications prior to said updated job specifications being implemented and consumed via execution of a build. For example, the system can generate one or more job specifications, such as an upgrade specification and a safest specification. An “upgrade specification” may refer to an updated job specification that includes one or more runtime parameters that are different from a prior version of the job specification. A “safest specification” may refer to a job specification that has been successfully executed by the system in the past, having one or more runtime parameters similar or identical to those of prior job specifications. The system can “test” the upgrade specification such as by executing the upgrade specification. In some embodiments, this may be done in a staging environment. If execution of the upgrade specification fails, the system may implement and consume the safest specification. For example, upon a failed execution of the upgrade specification, the system may be configured to (e.g., automatically) execute the safest specification. In this way, the system can provide a user with an updated job specification in the form of the upgrade specification and with job specification redundancy in the form of the safest specification. Advantageously, the system can help ensure that, whenever an update is pushed, subsequent runs of builds will not break as either the build will execute an upgrade specification that has satisfied any adjudication or a safest specification that is known to be issue-free.

By adjudicating updates to job specifications such as prior to running subsequent builds, the system can advantageously improve compute resource efficiency. For example, the system can minimize a need for hotfixes, emergency patches, and/or version rollbacks that may otherwise consume compute resources such as by wasting compute cycles associated with failed update rollouts. The system can further minimize a need for maintaining multiple active versions of the same job specification, which can otherwise require increased processing loads as different versions of job specifications may reference different datasets, dependencies, and/or the like, all of which may necessitate different computation, and can require increased storage demands as different versions of job specifications may store different dependencies, execution logs and metadata, and/or the like. The system can reduce (or minimize) resource contention than can result from different versions of the same job competing for compute resources. Moreover, the system can generate and adjudicate the upgrade and safest specifications without reducing (or while minimizing any reduction in) compute resource efficiency.

### Example System Associated with Adjudicating Job Specifications

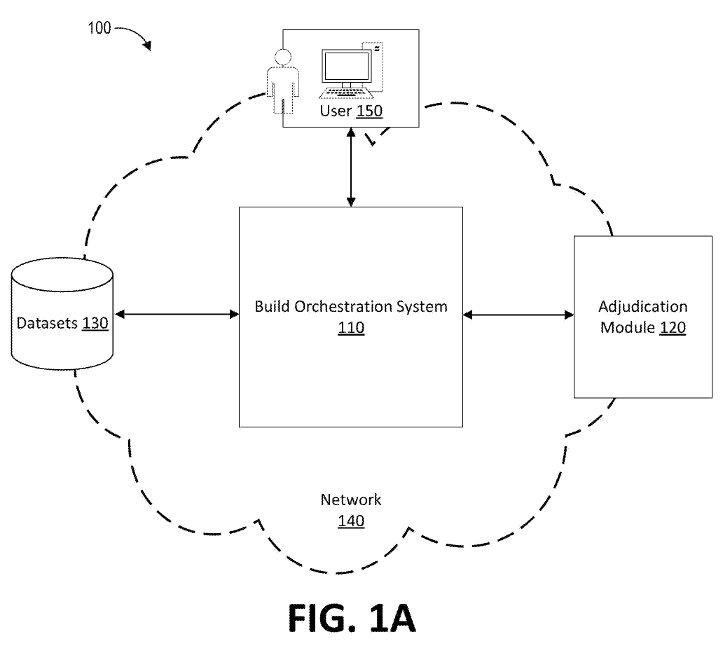

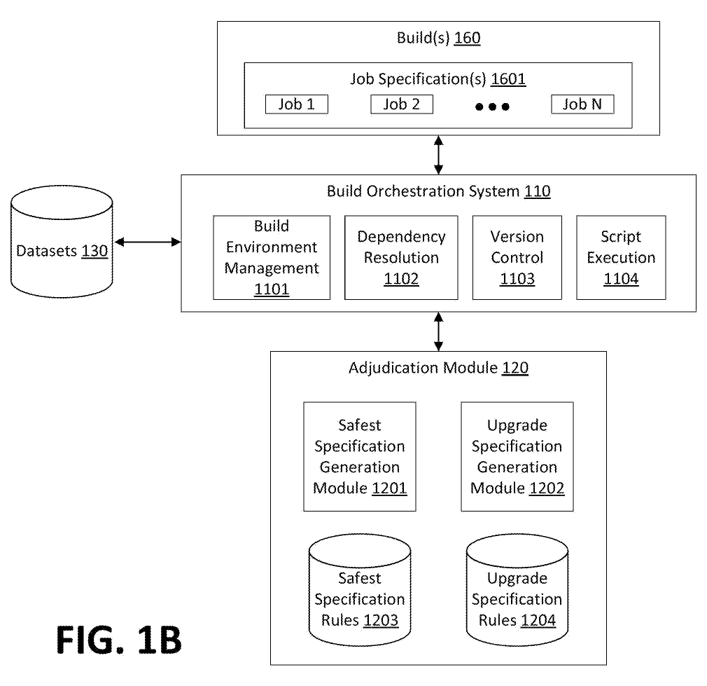

FIG. 1A is a block diagram illustrating an example computing environment 100, including aspects and/or components configured to adjudicate updates to data processing workflows. The computing environment 100 can include, but is not limited to, a build orchestration system 110, an adjudication module 120, datasets 130, network 140, and a user 150.

In the example of FIG. 1A, the various systems, devices, and/or components are in communication via a network 140, which may include any combination of networks, such as one or more local area network (LAN), personal area network (PAN), wide area network (WAN), the Internet, and/or any other communication network. In some embodiments, modules of the illustrated components (see FIG. 1B, for example,) may communicate via an internal bus and/or via the network 140.

The build orchestration system 110 is configured to manage, execute, and monitor computational workflows (also referred to herein as “data processing workflows”), such as may be associated with one or more builds. This can include data transformation and/or analytical workflows. For example, the build orchestration system 110 can schedule and execute builds, and/or monitor dependencies associated with builds. Advantageously, the build orchestration system 110 can manage large-scale processing of complex data pipelines across distributed systems, which can help improve computational efficiency in executing said pipelines by optimizing compute resource usage. For example, the build orchestration system 110 can schedule executions of builds and/or execute builds based on resource availability, incrementally process certain portions of builds and cache intermediate results for later processing, and allocate compute resources by scaling up or down resources depending on pipeline processing demands associated with a build.

The adjudication module 120 can be configured to adjudicate updates to builds that are to be executed by the build orchestration system 110. In some embodiments, the adjudication module 120 may adjudicate updates to job specifications associated with one or more jobs of a build. In this way, the adjudication module 120 can evaluate, validate, and decide whether changes to a build should be applied, modified, or rejected. Advantageously, the adjudication module 120 can help ensure that any updates to a build maintain data integrity, computational efficiency, and system reliability before being incorporated into said build. For example, the adjudication module 120 can be configured to generate one or more specifications, such as an update specification and a safest specification, as further described herein. The specifications can include information relating to which datasets and/or how said datasets should be processed and/or transformed. The adjudication module 120 can be configured to arbitrate between the two specifications to decide which of the two specifications should be implemented and consumed by the build orchestration system 110 for executing one or more associated jobs of a build. In some embodiments, the adjudication module 120 can generate 2 or more specifications, such as 2, 3, 4, or more specifications for potential use by the build orchestration system 110.

The build orchestration system 110, in some embodiments, can include the adjudication module 120. For example, the build orchestration system 110 and adjudication module 120 may be part of a common system. In some embodiments, the adjudication module 120 may be outside of the build orchestration system 110 and interface with the build orchestration system 110. For example, the adjudication module 120 may be locally hosted, cloud managed, or accessed via one or more Application Programming Interfaces (APIs), and/or any combination of the foregoing and/or the like. In some examples, the adjudication module 120 may be configured as a plug-in that can receive and respond to requests for data and/or data processing by the build orchestration system 110. The adjudication module 120 may be accessible via an API that is exposed to the build orchestration system 110 and allows data processing requests to be received via API calls from the build orchestration system 110. In some embodiments, the adjudication module 120 may be implemented as any available type of service, including but not limited to, browser extensions, widgets, add-ons applets, plug-ins, and/or the like, such as may execute on the build orchestration system 110 or on another system that is in communication with the build orchestration system 110. The adjudication module 120 may add and/or modify one or more functionalities of the build orchestration system 110 and/or components thereof.

Datasets 130 can include one or more sets of input data and/or one or more sets of output data. The input data may be useable by the build orchestration system 110 when executing one or more tasks associated with a data processing workflow, such as one or more jobs associated with a build. For example, the build orchestration system may receive or access one or more sets of input data for transformation and/or analysis. The build orchestration system may generate one or more sets of output data using the one or more sets of input data. In some embodiments, the build orchestration system 110 may generate one or more sets of output data, such as intermediate output data. Intermediate output data can include data generated during a portion of a data processing workflow, such as by a job of a build. In some embodiments, the build orchestration system 110 may generate final output data. Final output data can include data generated by completion of a data processing workflow, such as by the final job(s) of a build. In some embodiments, the build orchestration system 110 may generate other outputs, such as compiled code and/or other artifacts produced as a result of the build, such as (but not limited to): object files, library files, container images, configuration files, dependency lock files, data reports or logs, associated metadata, documentation, and/or the like.

Datasets 130 may be stored in one or more data stores, databases, storage components, storage systems, and/or any combination of the foregoing and/or the like, which can include any computer readable storage medium and/or device (or collection of data storage mediums and/or devices), including, but not limited to, one or more memory devices that store data, including without limitation, dynamic and/or static random access memory (RAM), programmable read-only memory (PROM), erasable programmable read-only memory (EPROM), electrically erasable programmable read-only memory (EEPROM), optical disks (e.g., CD-ROM, DVD-ROM, and/or the like), magnetic disks (e.g., hard disks, floppy disks, and/or the like), memory circuits (e.g., solid state drives, random-access memory (RAM), and/or the like), and/or the like. In some embodiments, datasets 130 may be stored locally on the build orchestration system 110. In some embodiment, the datasets 130 may be stored on one or more external servers that are in communication with the build orchestration system 110, such as via network 140.

In the example of FIG. 1A, a user 150 (which generally refers to a human user and/or computing device of any type that may be operated by a human user) provides user input that can cause and/or modify one or more operations and/or processes performed by the build orchestration system 110 and/or the adjudication module 120.

FIG. 1B is a block diagram illustrating interactions among components of the build orchestration system 110 and adjudication module 120. The build orchestration system 110 can execute one or more builds 160. The build orchestration system 110 can access one or more datasets 130 useable for executing the build(s) 160.

The build(s) 160 can be associated with one or more job specifications 1601. Each of the job specification(s) 1601 may be associated with a separate job 1 through N. One or more of the jobs 1 through N may operate on one or more sets of input data, such as from the datasets 130. In some embodiments, one or more of the jobs 1 through N may operate on an intermediate set of output data, such as computed by another job. Each of the jobs 1 through N may compute a set of output data in the datasets 130. In some embodiments, one or more of the jobs 1 through N may compute an intermediate set of output data or a final set of output data. In some embodiments, one or more of jobs 1 through N may generate compiled code and/or other artifacts that are produced as a result of the associated build(s) 160, such as described elsewhere herein.

The build orchestration system 110 can be configured to perform one or more operation and/or functions, including but not limited to, build environment management 1101, dependency resolution 1102, version control 1103, and script execution 1104.

Build environment management 1101 can include one or more processes and/or functions for configuring, maintaining, and optimizing an execution environment where one or more jobs 1 through N of a build 160 are compiled and executed. Advantageously, the build orchestration system 110 can ensure each execution of a job 1 through N of a build 160 occurs under the correct conditions, dependencies, compute resources, and/or security permissions. For example, the build orchestration system 110 can ‘read’ a job specification 1601 to identify an execution environment in which to execute a job associated with the job specification 1601. For example, the build orchestration system 110 can be configured to parse the job specification 1601. The build orchestration system 110 can set up the identified execution environment before executing the job, such as by provisioning the necessary hardware (e.g., CPU, memory, and/or the like) based on the requirements of the job. In some embodiments, the build orchestration system 110 may create an isolated execution environment for executing two or more jobs of jobs 1 through N in parallel, such as via implementing containers and/or virtual machines. In this way, the build orchestration system 110 can ensure that the jobs do not interfere with one another. The build orchestration system 110 may adjust compute allocation based on the job’s priority and/or resource constraints. The build orchestration system 110 can set up environment variables (e.g., databases, API keys, and/or the like) and/or execution parameters (e.g., batch size, timeout limits, and/or the like), and/or load configuration files. The build orchestration system 110 can establish connections to data sources, such as to access and/or write to datasets 130, and set up caching mechanisms for frequently accessed datasets. In some embodiments, the build orchestration system 110 can manage permissions and credentials such that only authorized users can execute certain builds 160 and/or access certain datasets 130. The build orchestration system 110 can monitor executions of one or more of jobs 1 through N and, in some embodiments, may handle failures. For example, if execution of a job fails, the build orchestration system 110 may retry the job, generate alerts and/or notifications, and/or log error messages for troubleshooting.

Dependency resolution 1102 can include one or more processes and/or functions for identifying, retrieving, and/or configuring required dependencies for executing one or more jobs 1 through N of one or more builds 160. The build orchestration system 110 may ‘read’ a job specification 1601 and identify one or more dependencies required for executing the job associated with the job specification. The build orchestration system 110 can retrieve and/or load the identified dependencies, such as via one or more package managers. In some embodiments, the build orchestration system 110 may download dependencies from a package repository. The build orchestration system 110 can cache dependencies locally for future executions, such as dependencies that are frequently used for executing jobs. The build orchestration system may install the dependency in the execution environment in which the job is to be executed.

Version control 1103 can include one or more processes and/or functions for managing and tracking different versions of build(s) 160 and/or job specification(s) 1601. Different versions of build(s) 160 and/or job specification(s) 1601 may be associated with different datasets, dependencies, and/or execution environments. For example, a first version of a job of a build 160 may input a first dataset, reference a first dependency, and/or be executed in a first execution environment, whereas a second version of the same job of the build 160 may input a different dataset, reference a different dependency (or a different version of the same dependency), and/or be executed in a different execution environment (or a different version of the same execution environment). Each time a job specification 1601 is updated, the build orchestration system 110 can assign a version number to track the update. In this way, the build orchestration system 110 can advantageously ensure that, for a particular version of a job specification 1601, the correct datasets 130 are referenced, the correct dependencies are retrieved, and the correct execution environment is provisioned. The build orchestration system 110 can log metadata indicative of who made the update, when the update was made, and/or the like. The build orchestration system 110 may maintain a history of previous versions of job specifications. The build orchestration system 110 may be configured to revert to previous versions of a job specification 1601 if an updated version of the job specification 1601 introduces breaks (e.g., bugs) into the associated build 160. In this way, the build orchestration system 110 can advantageously support development of a plurality of versions of a plurality of builds 160.

Script execution 1104 can include one or more processes and/or functions for executing a script and/or other executable code for executing a job. For example, when executing a job, the build orchestration system 110 may reference the dependency (or dependencies) that has been retrieved and installed in the execution environment, such as described hereinabove. Referencing the dependency can invoke the executable logic contained by the dependency. For example, when referencing a dependency, the build orchestration system 110 may execute a dependency executable that implements and consumes the logic of the dependency. Execution of the dependency executable may directly perform the data processing logic, initiate a call to a library function, initiate a call to an API, and/or the like. In this way, the build orchestration system 110 can perform one or more processes on one or more sets of input data to generate one or more sets of output data. In some embodiments, the build orchestration system 110 may perform one or more processes to generate compiled code and/or other artifacts that are produced as a result of executing build(s) 160, such as described elsewhere herein.

The adjudication module 120 can include, but is not limited to, a safest specification generation module 1201, an upgrade specification generation module 1202, safest specification rules 1203, and upgrade specification rules 1204.

The safest specification generation module 1201 can be configured to generate a safest specification, such as described herein. The safest specification may be a job specification that was successfully executed by the build orchestration system 110 in the past. In some embodiments, the safest specification can include one or more runtime parameters from one or more previous job specifications that were successfully executed by the build orchestration system 110. The safest specification generation module 1201 may be configured to generate the safest specification based at least on a previous job specification and a set of safest specification rules 1203. The safest specification generation module 1201 may provide the safest specification to the build orchestration system 110 for execution.

The upgrade specification generation module 1202 can be configured to generate an update specification, such as described herein. The upgrade specification may be a job specification having one or more runtime parameters that have been updated from previous job specifications. The upgrade specification generation module 1202 may be configured to generate the upgrade specification based at least on a previous job specification and a set of upgrade specification rules 1204. The upgrade specification generation module 1202 may provide the upgrade specification to the build orchestration system 110 for execution.

The safest specification rules 1203 can include one or more rules for generating and/or executing the safest specification. In this context, a “rule” can include execution constraints and/or execution conditions associated with generating and/or executing a job specification. “Execution constraints” can include information relating to runtime parameters (e.g., input datasets, output datasets, dependencies, execution environments, and/or the like) and/or versions of runtime parameters that are required for executing a job that is associated with the job specification. “Execution conditions” can include information relating to when a job specification should or should not be executed, what should happen if execution of a job specification is successful, and/or what should happen if execution of a job specification fails. Accordingly, the safest specification rules 1203 can include execution constraints and/or execution conditions associated with generating and/or executing the safest specification. Each rule in the set of safest specification rules 1203 may be associated with one or more portions of the safest specification. For example, each rule in the set of safest specification rules 1203 may be associated with a runtime parameter of the safest specification. In some embodiments, each rule in the set of safest specification rules 1203 may be configured to generate and/or update only the runtime parameter with which the respective rule is associated.

The upgrade specification rules 1204 can include one or more rules for generating the upgrade specification. In some embodiments, the upgrade specification rules 1204 can include execution constraints and/or execution conditions associated with generating and/or executing the upgrade specification. Each rule in the set of upgrade specification rules 1204 may be associated with one or more portions of the upgrade specification. For example, each rule in the set of upgrade specification rules 1204 may be associated with a runtime parameter of the upgrade specification. In some embodiments, each rule in the set of upgrade specification rules 1204 may be configured to generate and/or update only the runtime parameter with which the respective rule is associated.

In some embodiments, the rules 1203 and/or 1204 may be domain specific. For example, rules 1203 and/or 1204 may include execution constraints and/or conditions that are relevant only to a certain job of a build 160, and may not apply universally across all jobs and/or all builds 160. In some embodiment, the rules 1203 and/or 1204 may be system-wide such that the rules apply across different jobs of one or more builds 160. The rules 1203 and/or 1204 may be pre-defined, such as by a developer of a computing system that is to execute the job specification. In some embodiments, the rules 1203 and/or 1204 may be custom, such as defined by a user of the computing system that is to execute the job specification.

The adjudication module 120 may be configured to monitor and track the rules 1203 and/or 1204 that are used to generate the safest job specification and/or upgrade specification, respectively. In some embodiments, the adjudication module 120 may be configured to determine whether a rule has updated a runtime parameter with which the respective rule is not associated. In response, the adjudication module 120 may generate an alert and/or notification indicative of the improper update, and flag the updated runtime parameter for review. In some embodiments, the adjudication module 120 may generate visual indicia indicative of the alert/notification and render the visual indicia in an interactive graphical user interface (GUI) of a software application for visualization by a user (e.g., user 150).

The safest specification rules 1203 and/or upgrade specification rules 1204 may be stored in one or more data stores, databases, storage components, storage systems, and/or any combination of the foregoing and/or the like, which can include any computer readable storage medium and/or device (or collection of data storage mediums and/or devices), including, but not limited to, one or more memory devices that store data, including without limitation, dynamic and/or static random access memory (RAM), programmable read-only memory (PROM), erasable programmable read-only memory (EPROM), electrically erasable programmable read-only memory (EEPROM), optical disks (e.g., CD-ROM, DVD-ROM, and/or the like), magnetic disks (e.g., hard disks, floppy disks, and/or the like), memory circuits (e.g., solid state drives, random-access memory (RAM), and/or the like), and/or the like. In some embodiments, the rules 1203 and/or 1204 may be stored locally on the adjudication module 120. In some embodiment, the rules 1203 and/or 1204 may be stored on one or more external servers that are in communication with the adjudication module 120, such as via network 140.

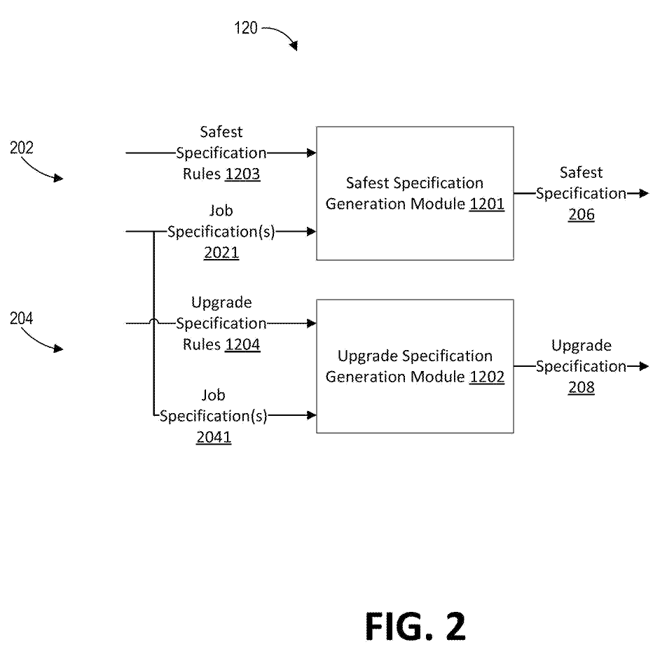

FIG. 2 is a block diagram illustrating data interactions among components of the adjudication module 120. The safest specification generation module 1201 and the upgrade specification generation module 1202 can be configured to receive one or more inputs 202 and 204, respectively. The safest specification generation module 1201 may be configured to generate the safest specification 206 based at least on the input 204. The upgrade specification generation module 1202 may be configured to generate the upgrade specification 208 based at least on the input 204.

Input 202 can include one or more job specifications 2021 and the safest specification rules 1203. Input 204 can include one or more job specifications 2041 and the upgrade specification rules 1204. The job specification(s) 2021 and/or 2041 can include one or more features and/or functions similar or identical to the job specification(s) 1601 such as shown and/or described with reference to FIG. 1B. In some embodiments, the job specification(s) 2021 may be the same as the job specification(s) 2041. The job specification(s) 2021, 2041 may include a job specification previously executed by the build orchestration system 110, such as a job specification successfully executed by the build orchestration system 110 in the past. In some embodiments, the job specification(s) 2021, 2041 may include the job specification most recently executed by the build orchestration system 110. In some embodiments, the job specification(s) 2021, 2041 may be an original job specification generated by the build orchestration system 110 for a scheduled run of the associated job.

The safest specification generation module 1201 may process the job specification(s) 2021 and the safest specification rules 1203 to generate the safest specification 206. For example, the safest specification generation module 1201 may ‘read’ (e.g., parse) the specification(s) 2021 to identify one or more runtime parameters of the specification(s) 2021 and check the safest specification rules 1203 against said runtime parameters. The safest specification generation module 1201 may evaluate the safest specification rules 1203 and update one or more parameters of the specification(s) 2021 to generate one or more runtime parameters of the safest specification 206. The safest specification rules 1203 may be associated with historical data, such as relating to previous successful executions of one or more job specifications 2021. In some embodiments, the safest specification 206 may be the same as the job specification(s) 2021. For example, the safest specification 206 may include one or more runtime parameters that are similar or identical to one or more runtime parameters of the specification(s) 2021. The safest specification generation module 1201 may provide the generated safest specification 206 to the build orchestration system 110.

In some embodiments, the safest specification rules 1203 can include a determination of whether one or more runtime parameters of the specification(s) 2021 are blacklisted. A runtime parameter may be “blacklisted” if the runtime parameter is listed (e.g., in metadata) as being undesirable and/or harmful. For example, the blacklisted runtime parameter may have failed a certain number of executions and/or introduced breaks (e.g., bugs, security vulnerabilities, and/or the like) into one or more jobs of one or more builds.

The safest specification rules 1203, in some embodiments, may include a determination of whether the runtime parameters associated with the specification(s) 2021 have been previously executed. For example, the system may be configured to determine whether said runtime parameters were the runtime parameters most recently executed by the build orchestration system 110.

In some embodiments, based on a determination that the runtime parameters of the specification(s) 2021 are not blacklisted and/or that the runtime parameters of the specification(s) 2021 are the most recently executed, the safest specification generation module 1201 may be configured to generate the safest specification for execution by the build orchestration system 110.

The upgrade specification generation module 1202 may process the job specification(s) 2041 and the upgrade specification rules 1204 to generate the upgrade specification 208. For example, the upgrade specification generation module 1202 may ‘read’ the specification(s) 2041 to identify one or more runtime parameters of the specification(s) 2041 and check the upgrade specification rules 1204 against said runtime parameters. The upgrade specification generation module 1202 may evaluate the upgrade specification rules 1204 and update one or more parameters of the specification(s) 2041 to generate one or more runtime parameters of the upgrade specification 208. The upgrade specification generation module 1202 may provide the generated upgrade specification 208 to the build orchestration system 110.

In some embodiments, the upgrade specification rules 1204 can include a determination of whether one or more runtime parameters of the specification(s) 2041 satisfy an upgrade threshold. The upgrade threshold can include one or more threshold condition(s) that determine whether an update to said runtime parameters is allowed, required, or restricted. For example, the threshold condition(s) may permit a certain number of updates within a certain period of time and/or may permit updates at certain times. The threshold condition(s) may be associated with runtime parameter weights. Weights may be based on priority, complexity, resource constraints, dataset dependencies (e.g., the number of downstream jobs affected by the update), and/or the like. For example, an update relating to updating a reference to a dataset may have a lower weight than an update relating to changing the runtime dependencies and/or execution environments for executing the associated job. Updates having a low or high priority may satisfy the upgrade threshold, and updates having a high or low priority may not satisfy the upgrade threshold, respectively.

In some embodiments, the upgrade specification rules 1204 can include a determination of upgrade availability. For example, an upgrade may be available if one or more input datasets, output datasets, runtime parameters, and/or execution environments associated with the upgrade runtime parameters are available for execution of the upgrade specification. In some embodiments, an upgrade may be available if a new version of compiled code and/or other artifacts (such as described herein) are available for use in executing the upgrade specification. An upgrade may not be available if one or more input datasets, output datasets, runtime parameters, and/or execution environments associated with the upgrade runtime parameters are not available for execution of the upgrade specification. In some embodiments, an upgrade may not be available if a new version of compiled code and/or other artifacts are not available for use in executing the upgrade specification.

The upgrade specification rules 1204, in some embodiments, may include a determination of whether one or more upgrade runtime parameters have previously failed to execute. For example, the system can track executions of the upgrade specification system-wide, such as when the upgrade specification is executed by other users.

In some embodiments, based on a determination that the runtime parameters of the specification(s) 2041 satisfy the upgrade threshold, that an upgrade is available, and/or that one or more upgrade runtime parameters have not previously failed to execute, the upgrade specification generation module 1202 may generate the upgrade specification for execution by the build orchestration system 110.

### Example User Interfaces Associated with Adjudicating Job Specifications

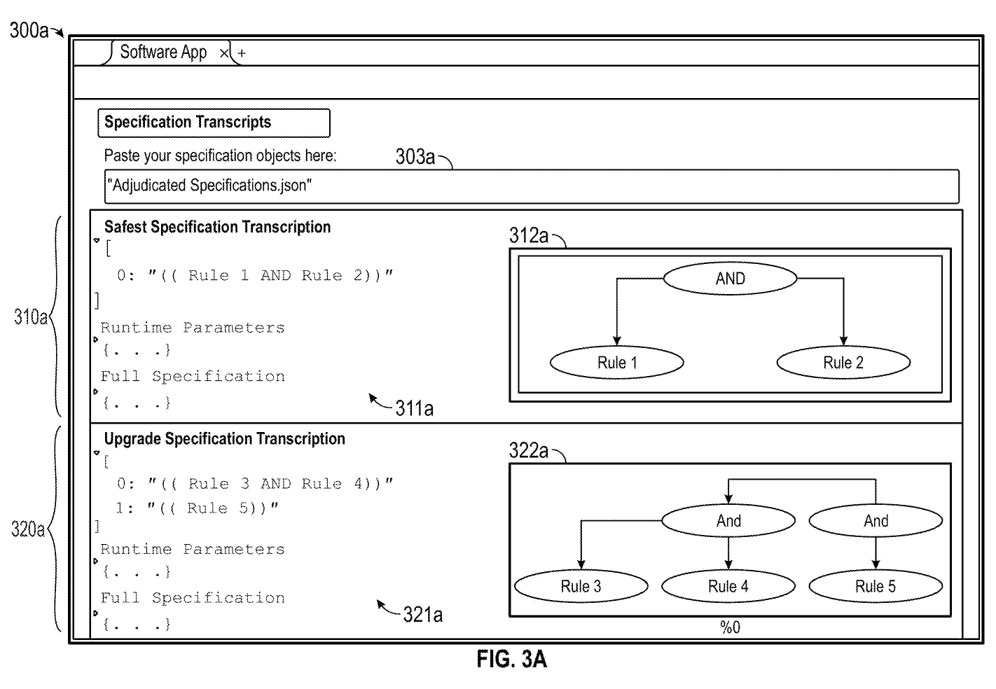

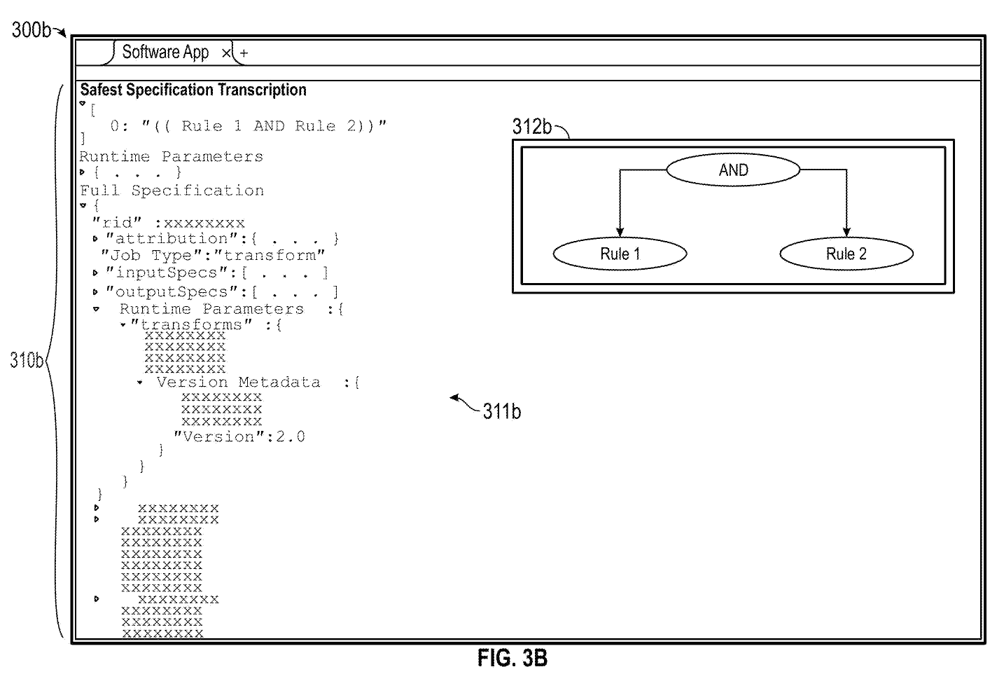

FIGS. 3A-3B illustrate example graphical user interfaces (GUIs) associated with adjudicating updates to job specifications of a build. FIG. 3A illustrates an example GUI 300a, such as may be displayed by a software application executing in a browser. However, this is not intended to be limiting. The GUI 300a may be displayed by any available type of software application such as may execute in any available type of execution environment. The GUI 300a may be an interactive GUI. The GUI 300a may be displayed by a computing device, such as user device 150 (see FIG. 1A, for example), which may comprise a computer, laptop, mobile device, tablet, phone, and/or the like. In some embodiments, the GUI 300a can be displayed on the user device 150 as part of an extension or plug-in to a browser where a software application may be executing. In some embodiments, the GUI 300a may be a native user interface such as a native user interface of a software application, a native user interface of the adjudication module 120, and/or a native user interface of the build orchestration system 110. In some embodiments, the GUI 300a can be displayed in a scroll-down menu of a mobile device and/or tablet. The GUI 300a may be any user interface visualized by a user as the user interacts with the build orchestration system 110 and/or adjudication module 120.

The GUI 300a can receive one or more inputs. The GUI 300a can facilitate adjudication of updates to job specifications. In some embodiments, the user device 150 may receive user input via GUI 300a, which may then allow the user device 150 to perform one or more operations based on the user input, such as triggering functionalities associated with generating and/or executing job specifications.

In the example of FIG. 3A, the GUI 300a includes, but is not limited to, a specification object field 302a, a safest specification transcript pane 310a, and an upgrade specification transcript pane 320a.

The specification object field 302a can be configured to receive an object and/or file associated with a generated specification, such as a text file. The specification object field 302a may be configured to be interactable with a user. For example, the specification object field 302a may be configured to receive user input. A user may input an object name and/or text file name into the specification object field 302a. In some examples, the specification object field 302a may be configured to support a drag-and-drop functionality. A user may drag and drop a specification object or text file into the specification object field 302a. In some examples, the specification object field 302a, when selected by a user, may display a drop-down menu that displays objects associated with generated job specifications for visualization by the user. A user may select a specification object from the menu, and the specification object field 302a may subsequently populate with the selected object. In the example embodiment illustrated in FIG. 3A, the specification object field 302a is populated with a JavaScript Object Notation (JSON) file; however, this is not intended to be limiting. Any available type of text file may be used, such as (but not limited to) Extensible Markup Language (XML) files, Comma Separated Values (CSV) files, and/or the like. Responsive to the specification object field 302a populating with a specification object and/or file, the system may retrieve or access the corresponding job specification for further display in the GUI 300a.

The safest specification transcript pane 310a can include, but is not limited to, a safest specification transcript field 311a and a safest specification rules visualization 312a. The safest specification transcript field 311a can populate with a transcript (e.g., text phrases) of the safest specification (e.g., safest specification 206), such as may be generated by the safest specification generation module 1201 (see FIG. 2, for example). The safest specification transcript field 311a can display at least a portion of a transcript associated with the safest specification. The safest specification transcript field 311a may populate with the safest specification transcript once a user has input and/or selected a job specification object and/or file in the specification object field 302a. The safest specification transcript can include text phrases representative of the rules, runtime parameters, and other information associated with the safest specification. In this way, the system can advantageously enable a user to monitor any updates made to a job specification and how those updates are made. The safest specification transcript field 311a can receive user input, such as modifying (e.g., adding, removing, editing, changing, etc.) any of the text of the generated transcript. For example, a user may modify any of the generated runtime parameters to fix any mistakes, include additional information, and the like, which can modify the safest specification. The system may store the modified safest specification in memory for retrieval by the build orchestration system 110 when executing the associated job.

The safest specification rules visualization 312a can include one or more graphical elements associated with the rules (e.g., safest specification rules 1203) that were used in generating the safest specification. The safest specification rules visualization 312a may provide a visualization of an execution constraint and/or execution condition associated with generating and/or executing the safest specification. In the example of FIG. 3A, the safest specification rules visualization 312a displays a Boolean logic tree associated with the safest specification rules. For example, to generate and/or execute the safest specification, Rule 1 and Rule 2 must be satisfied.

The upgrade specification transcript pane 320a can include, but is not limited to, an upgrade specification transcript field 321a and an upgrade specification rules visualization 322a. The upgrade specification transcript field 321a can populate with a transcript (e.g., text phrases) of the upgrade specification (e.g., upgrade specification 208), such as may be generated by the upgrade specification generation module 1202 (see FIG. 2, for example). The upgrade specification transcript field 321a can display at least a portion of a transcript associated with the upgrade specification. The upgrade specification transcript field 321a may populate with the upgrade specification transcript once a user has input and/or selected a job specification object and/or file in the specification object field 302a. The upgrade specification transcript can include text phrases representative of the rules, runtime parameters, and other information associated with the upgrade specification. In this way, the system can advantageously enable a user to monitor any updates made to a job specification and how those updates are made. The upgrade specification transcript field 321a can receive user input, such as modifying (e.g., adding, removing, editing, changing, etc.) any of the text of the generated transcript. For example, a user may modify any of the generated runtime parameters to fix any mistakes, include additional information, and the like, which can modify the upgrade specification. The system may store the modified upgrade specification in memory for retrieval by the build orchestration system 110 when executing the associated job.

The upgrade specification rules visualization 322a can include one or more graphical elements associated with the rules (e.g., upgrade specification rules 1204) that were used in generating the upgrade specification. The upgrade specification rules visualization 322a may provide a visualization of an execution constraint and/or execution condition associated with generating and/or executing the upgrade specification. In the example of FIG. 3A, the upgrade specification rules visualization 322a displays a Boolean logic tree associated with the upgrade specification rules. For example, to generate and/or execute the upgrade specification, Rule 3, Rule 4, and Rule 5 must be satisfied.

Moving to FIG. 3B, GUI 300b can include a safest specification transcript pane 310b having (but not limited to) a safest specification transcript field 311b and a safest specification rules visualization 312b. The GUI 300b can include one or more features and/or functions similar or identical to any of those of GUI 300a such as shown and/or described with reference to FIG. 3A. The safest specification transcript field 311b and the safest specification rules visualization 312b can include one or more features and/or functions similar or identical to any of those of the safest specification transcript field 311a and the safest specification rules visualization 312a, respectively, such as shown and/or described with reference to FIG. 3A. In the example embodiment of FIG. 3B, a user has selected a portion of the safest specification transcript to expand the transcript. In this way, the user may visualize more information associated with the safest specification. As illustrated in the example of FIG. 3B, the user has selected “Full Specification” and then “Runtime Parameters” to cause display of the runtime parameters associated with the safest specification. Advantageously, the user may visualize the runtime parameters of the safest specification generated by the system to monitor any changes to said parameters.

### Example Processes Relating to Adjudicating Updates to Job Specifications

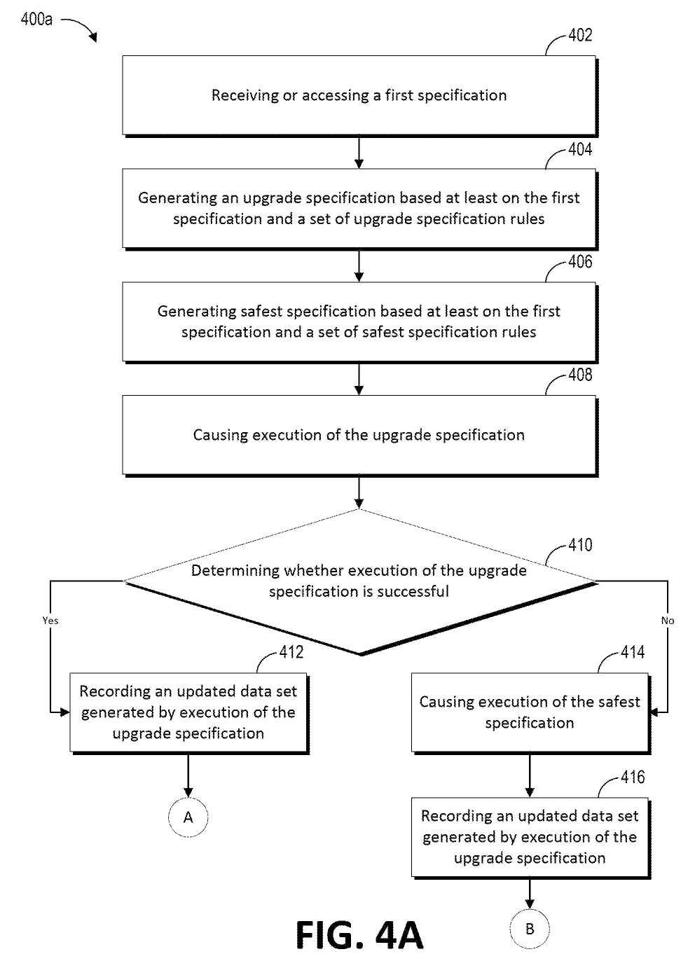

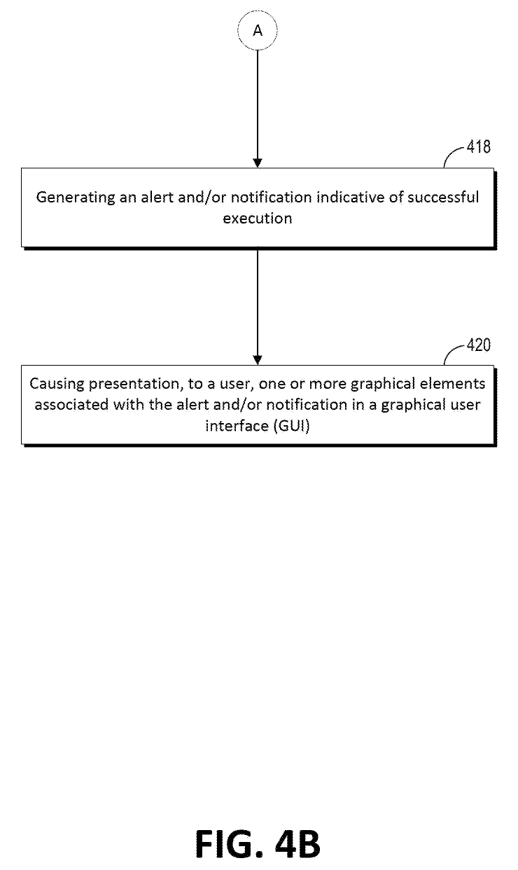

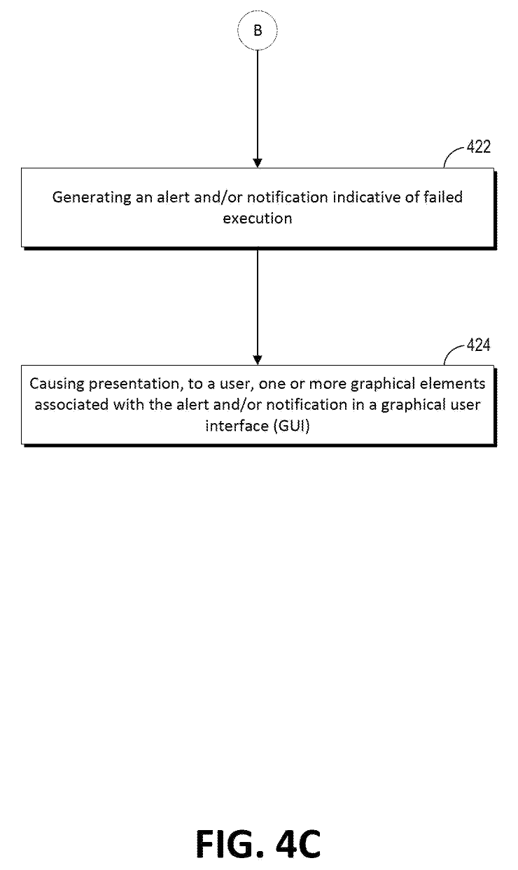

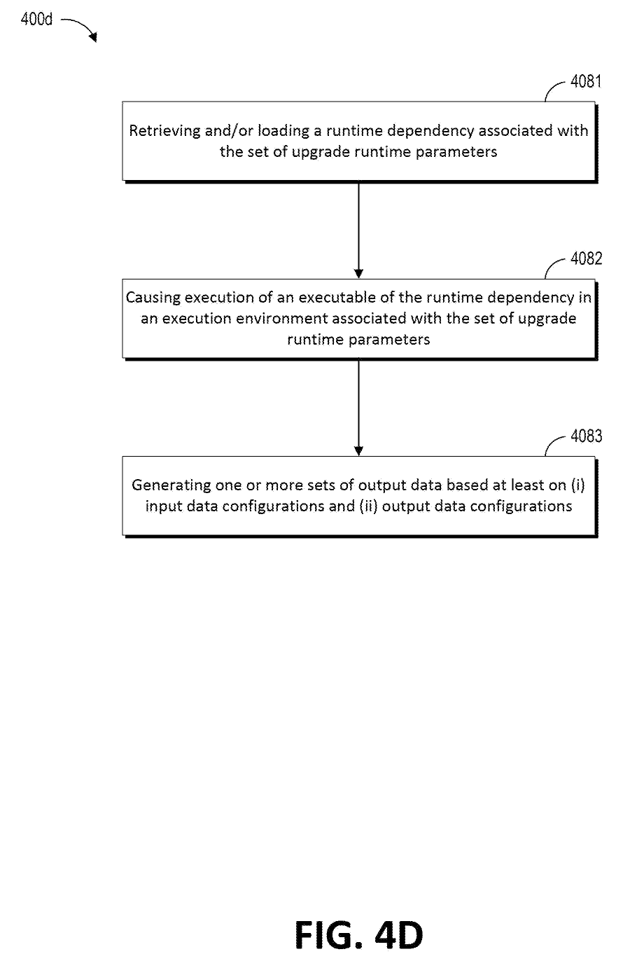

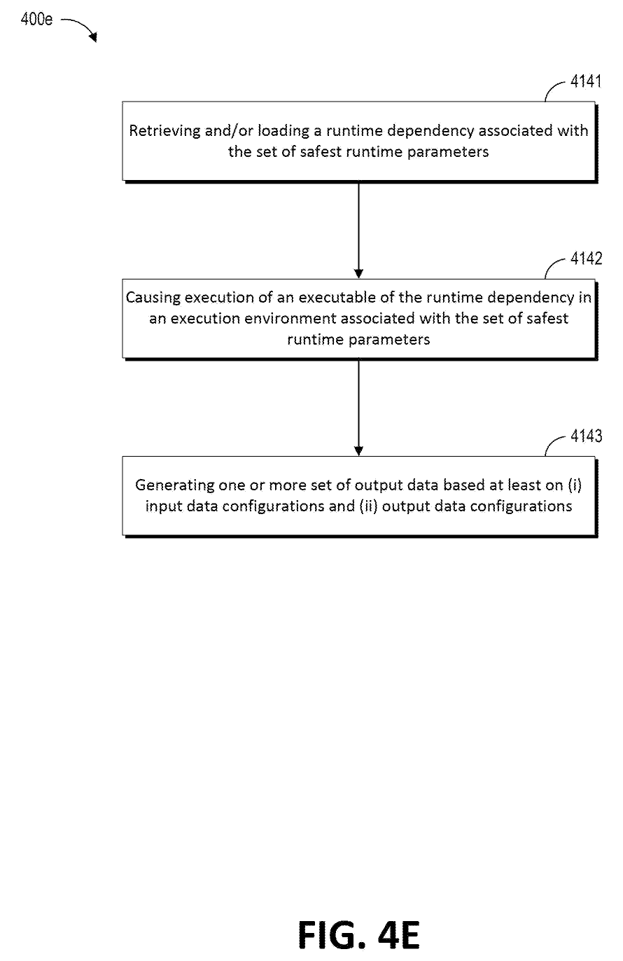

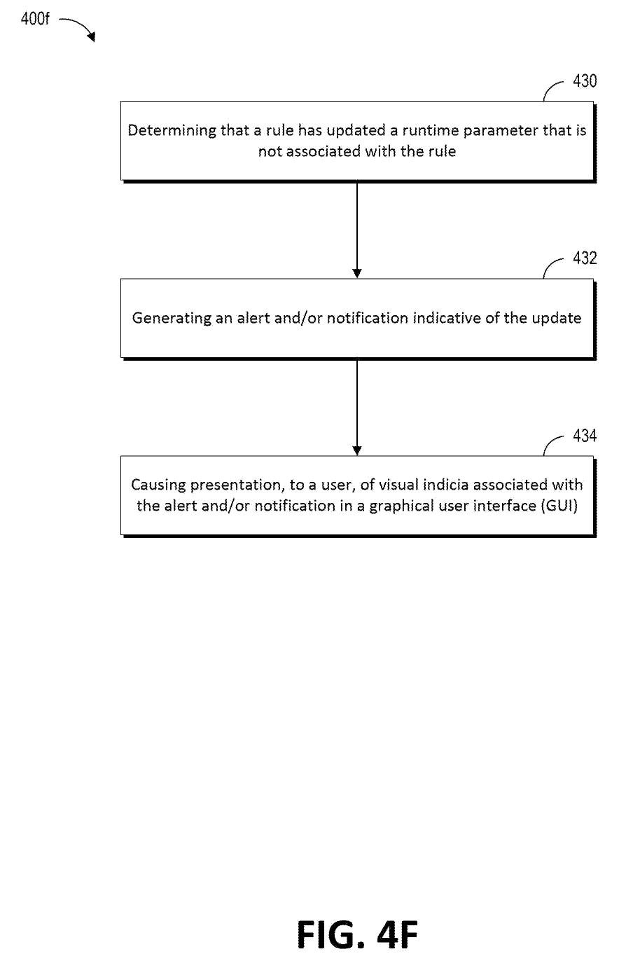

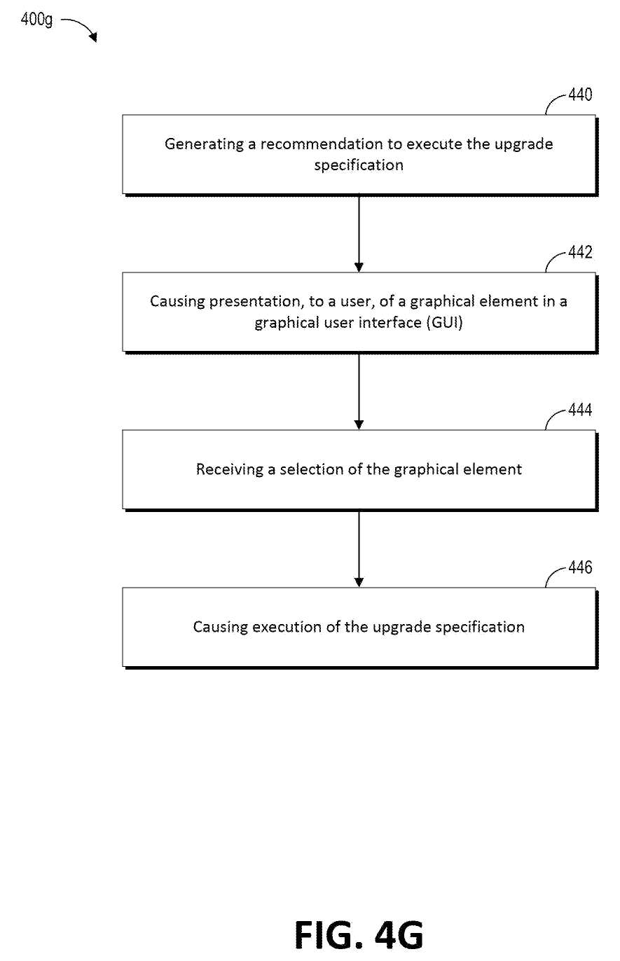

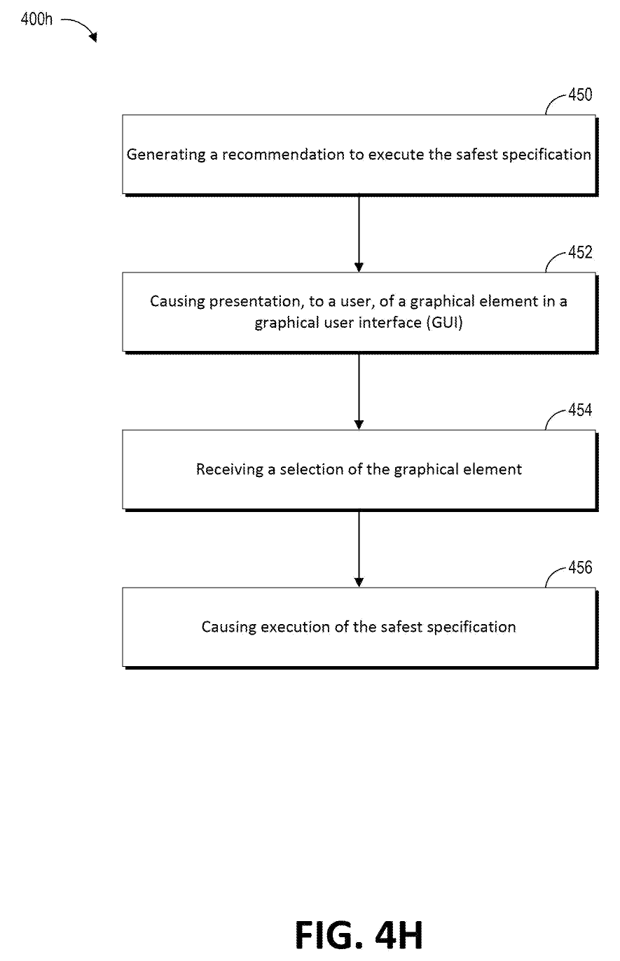

FIG. 4A is a flow diagram illustrating an example process 400a for adjudicating updates to job specifications. The process 400a, or portions thereof, can be implemented by a computing device such as a hardware processor. The process 400a, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400a serves as an example and is not intended to restrict the present disclosure. In some embodiments, the process 400a, or portions thereof, can be performed by a computing device associated with the build orchestration system 110, such as the adjudication module 120 and/or one or more components thereof as described herein.

Beginning at block 402, a hardware computer processor (e.g., associated with adjudication module 120 and/or components thereof) can be configured to receive or access a first specification. The first specification may be an original job specification generated by the build orchestration system 110, such as for a scheduled run of an associated build. The first specification can include information indicative of a first set of runtime parameters. The first set of runtime parameters may be associated with a job of a build. In this way, the first set of runtime parameters may be associated with a data processing workflow that is to be applied to a dataset.

At block 404, the processor can be configured to generate an upgrade specification. The processor may generate the upgrade specification based at least on the first specification and a set of upgrade specification rules (e.g., upgrade specification rules 1204). The upgrade specification can include information indicative of a set of upgrade runtime parameters, such as may be associated with the job of the build. In this way, the upgrade runtime parameters may be associated with the data processing workflow. One or more of the upgrade runtime parameters may be updated from the first set of runtime parameters, such as according to one or more of the upgrade specification rules. The set of upgrade specification rules may be configured to cause updates to certain of the first set of runtime parameters to generate the set of upgrade runtime parameters.

In some embodiments, at block 404, the set of upgrade specification rules can include a determination of whether the first set of runtime parameters satisfy an upgrade threshold. For example, the upgrade threshold can include one or more threshold condition(s) evaluated by the processor to determine whether an update to one or more of the first set of runtime parameters is allowed, required, or restricted, such as described herein.

In some embodiments, the set of upgrade specification rules can include a determination of whether an upgrade is available. For example, the processor may be configured to determine whether one or more input datasets, output datasets, runtime dependencies, and/or execution environments associated with the upgrade runtime parameters are available for executing the upgrade specification. In some examples, the processor may be configured to determine whether a new version of compiled code and/or other artifacts are available for use in executing the upgrade specification. This can include, but is not limited to, object files, library files, container images, configuration files, dependency lock files, data reports or logs, associated metadata, documentation, and/or the like.

At block 404, in some embodiments, the upgrade specification rules may include a determination of whether one or more upgrade parameters have previously failed to execute. For example, the processor may be configured to track executions of the upgrade parameters by other users. Based on a determination that the first set of upgrade parameters satisfy the upgrade threshold, that the upgrade is available, and/or that none of the upgrade parameters have previously failed to execute, the processor may be configured to generate the upgrade specification.

At block 406, the processor can be configured to generate a safest specification. The processor may generate the safest specification based at least on the first specification and a set of safest specification rules (e.g., safest specification rules 1203). The safest specification can include information indicative of a set of safest runtime parameters, such as may be associated with the job of the build. In this way, the safest runtime parameters may be associated with the data processing workflow. One or more of the safest runtime parameters may be different from the upgrade runtime parameters. One or more of the safest runtime parameters may be similar or identical to the first runtime parameters, such as according to one or more of the safest specification rules. The set of safest specification rules may be associated with historical data indicative of previously successful executions of the associated job. In this way, in some embodiments, at block 406, the set of safest runtime parameters can include one or more runtime parameters from previous successfully executed sets of runtime parameters associated with the data processing workflow. In some embodiments, the set of safest runtime parameters may be the same as the first set of runtime parameters.

At block 406, the set of safest specification rules can include a determination of whether the first set of runtime parameters is backlisted. For example, one or more runtime parameters of the first set of runtime parameters may be backlisted if they have been listed as undesirable and/or harmful, such as described herein. In some embodiments, the set of safest specification rules may include a determination of whether one or more of the safest runtime parameters have been previously executed. For example, the processor may be configured to determine whether one or more of the safest runtime parameters were the most recently executed runtime parameters. Based on a determination that the first set of runtime parameters is not blacklisted and/or a determination that the first set of runtime parameters is the most recently executed set of runtime parameters, the processor may be configured to generate the safest specification.

Each of the sets of safest and upgrade runtime parameters can include information representative of one or more of: input data configurations; output data configuration; a job name; a job type; a job version; an execution environment, and/or a runtime dependency, such as described elsewhere herein.

At block 408, the processor can cause execution of the upgrade specification. For example, the processor can cause execution of one or more upgrade runtime parameters of the set of upgrade runtime parameters. In some embodiments, at block 408, the processor may be configured to cause execution of the upgrade specification automatically without requiring additional user activity.

At block 410, the processor can be configured to determine whether execution of the upgrade specification was successful. Execution may be successful if the associated job completes without any errors.

Responsive to a determination at block 410 that the execution of the upgrade specification was successful, the process 400a may proceed to block 412. At block 412, the processor may be configured record data (e.g., metadata) indicative of the successful execution. In some embodiments, the processor may record an updated dataset generated via execution of the upgrade specification. In FIG. 4A, block 412 is connected to a circle annotated with reference alpha “A” indicating that the process 400a optionally continues between FIGS. 4A and 4B. Although multiple blocks are illustrated in FIG. 4B, not all blocks may necessarily be performed in the ordinary course when performing processes associated with adjudicating job specifications. Moreover, although blocks depicted in FIG. 4B are illustrated in a particular order, this is not intended to be limiting. One or more blocks illustrated in FIG. 4B may be performed in one or more different orders, may be performed simultaneously, may be combined into fewer blocks, may be separated into additional blocks, or may not be performed at all.

As illustrated in FIG. 4B, in some embodiments, the process 400a may proceed to block 418. At block 418, the processor can be configured to generate an alert and/or notification indicative of the successful execution of the upgrade specification. The alert and/or notification can include visual, auditory, and/or haptic feedback.

At block 420, the processor can be configured to generate user interface data associated with the alert and/or notification, and render the user interface data in a graphical user interface (GUI), such as in a GUI of a software application executing in a browser or any other available type of execution environment. The GUI may be an interactive GUI. The processor may cause presentation of one or more graphical elements associated with the alert or notification in the GUI of the software application. Although GUIs are described in the context of software applications, this is not intended to be limiting. The GUI may be a native user interface of the build orchestration system 110 and/or the adjudication module 120.

Returning to FIG. 4A, responsive to a determination at block 410 that the execution of the upgrade specification was not successful, the process 400a may proceed to block 414. At block 414, the processor may cause execution of the safest specification. For example, the processor can cause execution of one or more safest runtime parameters of the set of safest runtime parameters. In some embodiments, at block 414, the processor may be configured to cause execution of the safest specification automatically without requiring additional user activity.

At block 416, the processor can be configured to record data indicative of the execution of the safest specification. In some embodiments, the processor can record an updated dataset generated via execution of the safest specification. In FIG. 4A, block 416 is connected to a circle annotated with reference beta “B” indicating that the process 400a optionally continues between FIGS. 4A and 4C.

Although multiple blocks are illustrated in FIG. 4C, not all blocks may necessarily be performed in the ordinary course when performing processes associated with adjudicating job specifications. Moreover, although blocks depicted in FIG. 4C are illustrated in a particular order, this is not intended to be limiting. One or more blocks illustrated in FIG. 4C may be performed in one or more different orders, may be performed simultaneously, may be combined into fewer blocks, may be separated into additional blocks, or may not be performed at all.

As illustrated in FIG. 4C, in some embodiments, the process 400a may proceed to block 422. At block 422, the processor can be configured to generate an alert and/or notification indicative of the failed execution of the upgrade specification. The alert and/or notification can include visual, auditory, and/or haptic feedback. In some embodiments, the processor may be configured to implement a health check. For example, the processor may generate the alert and/or notification after a certain number of failed executions of the upgrade specification.

At block 424, the processor can be configured to generate user interface data associated with the alert and/or notification, and render the user interface data in a graphical user interface (GUI), such as in a GUI of a software application executing in a browser or any other available type of execution environment. The GUI may be an interactive GUI. The processor may cause presentation of one or more graphical elements associated with the alert or notification in the GUI of the software application. Although GUIs are described in the context of software applications, this is not intended to be limiting. The GUI may be a native user interface of the build orchestration system 110 and/or the adjudication module 120.

FIG. 4D is a flow diagram illustrating an example process 400d for adjudicating updates to job specifications. The process 400d, or portions thereof, can be implemented by a computing device such as a hardware processor. The process 400d, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400d serves as an example and is not intended to restrict the present disclosure. In some embodiments, the process 400d, or portions thereof, can be performed by a computing device associated with the build orchestration system 110, such as the adjudication module 120 and/or one or more components thereof as described herein.

Although multiple blocks are illustrated in FIG. 4D, not all blocks may necessarily be performed in the ordinary course when performing processes associated with adjudicating updates to job specifications. In some embodiments, the process 400d may be a subprocess. For example, the process 400d may be a subprocess associated with one or more blocks of process 400a. Moreover, although blocks depicted in FIG. 4D are illustrated in a particular order, this is not intended to be limiting. One or more blocks illustrated in FIG. 4D may be performed in one or more different orders, may be performed simultaneously, may be combined into fewer blocks, may be separated into additional blocks, or may not be performed at all.

Beginning at block 4081, when executing an upgrade specification, a processor (e.g., associated with the adjudication module 120 and/or components thereof) can be configured to resolve a dependency associated with the set of upgrade runtime parameters. For example, the processor may retrieve the runtime dependency, such as from a package repository. The processor may load the runtime dependency in an execution environment associated with the set of upgrade runtime parameters. The processor may be configured to set up the execution environment, such as described elsewhere herein.

At block 4082, the processor may be configured to cause execution of an executable of the runtime dependency in the execution environment. For example, the processor may execute executable code bundled within the dependency, initiate a call to a library function, initiate a call to an API, and/or the like.

At block 4083, the processor can be configured to generate one or more sets of output data. The processor may generate the output data based at least on the input data configurations and output data configurations associated with the set of upgrade runtime parameters. For example, the processor may receive or access one or more sets of input data and compute one or more sets of output data using at least some of the input data. The processor may perform one or more operations and/or functions on the input data according to the executable logic contained by the dependency. In some embodiments, the processor may be configured to generate compiled code and/or other artifacts produced as a result of job(s) and/or build associated with the set of upgrade runtime parameters. This can include, but is not limited to, object files, library files, container images, configuration files, dependency lock files, data reports or logs, associated metadata, documentation, and/or the like.

FIG. 4E is a flow diagram illustrating an example process 400e for adjudicating updates to job specifications. The process 400e, or portions thereof, can be implemented by a computing device such as a hardware processor. The process 400e, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400e serves as an example and is not intended to restrict the present disclosure. In some embodiments, the process 400e, or portions thereof, can be performed by a computing device associated with the build orchestration system 110, such as the adjudication module 120 and/or one or more components thereof as described herein.

Although multiple blocks are illustrated in FIG. 4E, not all blocks may necessarily be performed in the ordinary course when performing processes associated with adjudicating updates to job specifications. In some embodiments, the process 400e may be a subprocess. For example, the process 400e may be a subprocess associated with one or more blocks of process 400a. Moreover, although blocks depicted in FIG. 4E are illustrated in a particular order, this is not intended to be limiting. One or more blocks illustrated in FIG. 4E may be performed in one or more different orders, may be performed simultaneously, may be combined into fewer blocks, may be separated into additional blocks, or may not be performed at all.

Beginning at block 4141, when executing a safest specification, a processor (e.g., associated with the adjudication module 120 and/or components thereof) can be configured to resolve a dependency associated with the set of safest runtime parameters. For example, the processor may retrieve the runtime dependency, such as from a package repository. The processor may load the runtime dependency in an execution environment associated with the set of safest runtime parameters. The processor may be configured to set up the execution environment, such as described elsewhere herein.

At block 4142, the processor may be configured to cause execution of an executable of the runtime dependency in the execution environment. For example, the processor may execute executable code bundled within the dependency, initiate a call to a library function, initiate a call to an API, and/or the like.

At block 4143, the processor can be configured to generate one or more sets of output data. The processor may generate the output data based at least on the input data configurations and output data configurations associated with the set of safest runtime parameters. For example, the processor may receive or access one or more sets of input data and compute one or more sets of output data using at least some of the input data. The processor may perform one or more operations and/or functions on the input data according to the executable logic contained by the dependency. In some embodiments, the processor may be configured to generate compiled code and/or other artifacts produced as a result of the job(s) and/or build associated with the set of safest runtime parameters. This can include, but is not limited to, object files, library files, container images, configuration files, dependency lock files, data reports or logs, associated metadata, documentation, and/or the like.

FIG. 4F is a flow diagram illustrating an example process 400f for adjudicating updates to job specifications. The process 400f, or portions thereof, can be implemented by a computing device such as a hardware processor. The process 400f, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400f serves as an example and is not intended to restrict the present disclosure. In some embodiments, the process 400f, or portions thereof, can be performed by a computing device associated with the build orchestration system 110, such as the adjudication module 120 and/or one or more components thereof as described herein.

Although multiple blocks are illustrated in FIG. 4F, not all blocks may necessarily be performed in the ordinary course when performing processes associated with adjudicating updates to job specifications. In some embodiments, the process 400f may be a background process. For example, one or more blocks of process 400f may be performed while one or more blocks of process 400a are performed. In some examples, one or more blocks of process 400f may be performed while one or more blocks of a subprocess (e.g., process 400d and/or 400e) are performed. Moreover, although blocks depicted in FIG. 4F are illustrated in a particular order, this is not intended to be limiting. One or more blocks illustrated in FIG. 4F may be performed in one or more different orders, may be performed simultaneously, may be combined into fewer blocks, may be separated into additional blocks, or may not be performed at all.

Beginning at block 430, a processor (e.g., associated with the adjudication module 120 and/or components thereof) may be configured to determine whether a rule has updated a runtime parameter that is not associated with the respective rule. For example, at block 430, the processor may be configured to determine whether a rule of the set of upgrade specification rules has updated an upgrade runtime parameter that is not associated with the respective upgrade specification rule. In some examples, at block 430, the processor may be configured to determine whether a rule of the set of safest specification rules has updated a safest runtime parameter that is not associated with the respective safest specification rule.

At block 432, responsive to a determination that a rule has updated a runtime parameter that is not associated with the respective rule, the processor may be configured to generate an alert and/or notification indicative of the improper update. The alert and/or notification can include visual, auditory, and/or haptic feedback. In some embodiments, the processor may be configured to implement a health check. For example, the processor may generate the alert and/or notification after a certain number (e.g., a threshold number) of improper updates to runtime parameters.

At block 434, the processor can be configured to generate user interface data associated with the alert and/or notification, and render the user interface data in a graphical user interface (GUI), such as in a GUI of a software application executing in a browser or any other available type of execution environment. The GUI may be an interactive GUI. The processor may cause presentation of one or more graphical elements associated with the alert or notification in the GUI of the software application. Although GUIs are described in the context of software applications, this is not intended to be limiting. The GUI may be a native user interface of the build orchestration system 110 and/or the adjudication module 120.

FIG. 4G is a flow diagram illustrating an example process 400g for adjudicating updates to job specifications. The process 400g, or portions thereof, can be implemented by a computing device such as a hardware processor. The process 400g, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400g serves as an example and is not intended to restrict the present disclosure. In some embodiments, the process 400g, or portions thereof, can be performed by a computing device associated with the build orchestration system 110, such as the adjudication module 120 and/or one or more components thereof as described herein.

Although multiple blocks are illustrated in FIG. 4G, not all blocks may necessarily be performed in the ordinary course when performing processes associated with adjudicating updates to job specifications. Moreover, although blocks depicted in FIG. 4G are illustrated in a particular order, this is not intended to be limiting. One or more blocks illustrated in FIG. 4G may be performed in one or more different orders, may be performed simultaneously, may be combined into fewer blocks, may be separated into additional blocks, or may not be performed at all.

Beginning at block 440, a processor (e.g., associated with the adjudication module 120 and/or components thereof) may be configured to generate a recommendation to execute the upgrade specification. For example, responsive to generating the upgrade specification, the processor may generate the recommendation to execute the upgrade specification.

At block 442, the processor can be configured to generate user interface data associated with the recommendation, and render the user interface data in a graphical user interface (GUI), such as in a GUI of a software application executing in a browser or any other available type of execution environment. The GUI may be an interactive GUI. The processor may cause presentation of one or more graphical elements associated with the recommendation in the GUI of the software application. Although GUIs are described in the context of software applications, this is not intended to be limiting. The GUI may be a native user interface of the build orchestration system 110 and/or the adjudication module 120.

At block 444, the processor can be configured to receive a selection of the graphical element. For example, the user may select the graphical element such as by interacting with the GUI. The processor may receive a user selection of the graphical element via the software application.

At block 446, responsive to receiving the selection of the graphical element, the processor may be configured to execute the upgrade specification. For example, the processor may cause execution of one or more upgrade runtime parameters, such as described herein. In some embodiments, the processor may prohibit execution of the upgrade specification until the graphical element has been selected.

FIG. 4H is a flow diagram illustrating an example process 400h for adjudicating updates to job specifications. The process 400h, or portions thereof, can be implemented by a computing device such as a hardware processor. The process 400h, or portions thereof, can be executed by one or more hardware processors, whether they are associated with a singular or multiple computing devices like user device 150, build orchestration system 110, adjudication module 120, and/or devices in remote or wireless communication. The implementation may vary. For example, it could be controlled by processors related to a system, such as build orchestration system 110, or can involve modifications like omitting blocks, adding blocks, and/or rearranging the order of execution of the blocks. The process 400h serves as an example and is not intended to restrict the present disclosure. In some embodiments, the process 400h, or portions thereof, can be performed by a computing device associated with the build orchestration system 110, such as the adjudication module 120 and/or one or more components thereof as described herein.

Although multiple blocks are illustrated in FIG. 4H, not all blocks may necessarily be performed in the ordinary course when performing processes associated with adjudicating updates to job specifications. Moreover, although blocks depicted in FIG. 4H are illustrated in a particular order, this is not intended to be limiting. One or more blocks illustrated in FIG. 4H may be performed in one or more different orders, may be performed simultaneously, may be combined into fewer blocks, may be separated into additional blocks, or may not be performed at all.

Beginning at block 450, a processor (e.g., associated with the adjudication module 120 and/or components thereof) may be configured to generate a recommendation to execute the safest specification. For example, responsive to generating the safest specification, the processor may generate the recommendation to execute the safest specification.

At block 452, the processor can be configured to generate user interface data associated with the recommendation, and render the user interface data in a graphical user interface (GUI), such as in a GUI of a software application executing in a browser or any other available type of execution environment. The GUI may be an interactive GUI. The processor may cause presentation of one or more graphical elements associated with the recommendation in the GUI of the software application. Although GUIs are described in the context of software applications, this is not intended to be limiting. The GUI may be a native user interface of the build orchestration system 110 and/or the adjudication module 120.

At block 454, the processor can be configured to receive a selection of the graphical element. For example, the user may select the graphical element such as by interacting with the GUI. The processor may receive a user selection of the graphical element via the software application.

At block 456, responsive to receiving the selection of the graphical element, the processor may be configured to execute the safest specification. For example, the processor may cause execution of one or more safest runtime parameters, such as described herein. In some embodiments, the processor may prohibit execution of the safest specification until the graphical element has been selected.

### Additional Example implementations and Details

In an implementation, the systems or devices described herein (e.g., one or more aspects of the build orchestration system 110, adjudication module 120, user device 150, and/or the like) may comprise, or be implemented in, a “virtual computing environment”. As used herein, the term “virtual computing environment” should be construed broadly to include, for example, computer-readable program instructions executed by one or more processors to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user’s computer (e.g., the executing computing device), partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

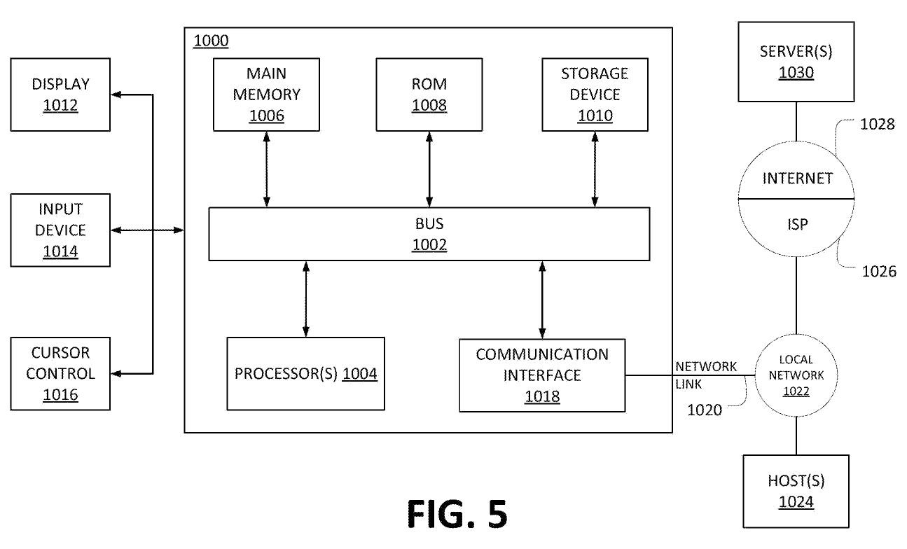

For example, FIG. 5 shows a block diagram that illustrates a computer system 1000 upon which various implementations and/or aspects (e.g., one or more aspects of the build orchestration system 110, adjudication module 120, user device 150, and/or the like) may be implemented. Multiple such computer systems 1000 may be used in various implementations of the present disclosure. Computer system 1000 includes a bus 1002 or other communication mechanism for communicating information, and a hardware processor, or multiple processors, 1004 coupled with bus 1002 for processing information. Hardware processor(s) 1004 may be, for example, one or more general purpose microprocessors.

Computer system 1000 also includes a main memory 1006, such as a random-access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. The main memory 1006 may, for example, include instructions to implement server instances, queuing modules, memory queues, storage queues, user interfaces, and/or other aspects of functionality of the present disclosure, according to various implementations.

Computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), and/or the like, is provided and coupled to bus 1002 for storing information and instructions.

Computer system 1000 may be coupled via bus 1002 to a display 1012, such as a cathode ray tube (CRT) or LCD display (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computing system 1000 may include a user interface module to implement a GUI that may be stored in a mass storage device as computer executable program instructions that are executed by the computing device(s). Computer system 1000 may further, as described below, implement the techniques described herein using customized hard-wired logic, one or more ASICs or FPGAs, firmware, and/or program logic which in combination with the computer system causes or programs computer system 1000 to be a special-purpose machine. According to one implementation, the techniques herein are performed by computer system 1000 in response to processor(s) 1004 executing one or more sequences of one or more computer-readable program instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicate with a WAN). Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user’s computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds at which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Aspects

Examples of implementations of the present disclosure can be described in view of the following example aspects or clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example aspects below, or any features of the example aspects, can be combined with any one or more other example aspects, or features of the example aspects or other features of the present disclosure.

Clause 1. A computer-implemented method for adjudicating updates to one or more runtime parameters associated with a data processing workflow, the computer-implemented method comprising, by one or more processors executing program instructions: receiving or accessing a first specification, wherein the first specification comprises information indicative of a first set of runtime parameters associated with a data processing workflow to be applied to a dataset; generating an upgrade specification based at least on the first specification and a set of upgrade specification rules, wherein the upgrade specification comprises information indicative of a set of upgrade runtime parameters associated with the data processing workflow, wherein the set of upgrade runtime parameters comprises one or more runtime parameters that are updated from the first set of runtime parameters, and wherein the set of upgrade specification rules is configured to cause updates to certain of the first set of runtime parameters to obtain the set of upgrade runtime parameters; generating a safest specification based at least on the first specification and a set of safest specification rules, wherein the safest specification comprises information indicative of a set of safest runtime parameters associated with the data processing workflow, wherein the set of safest runtime parameters comprises one or more runtime parameters from the first set of runtime parameters, wherein the set of safest specification rules is associated with historical data indicative of previously successful executions of the data processing workflow, and wherein the set of safest runtime parameters is different from the set of upgrade runtime parameters; causing execution of the upgrade specification; determining whether the execution of the upgrade specification is successful, wherein the execution is successful if the execution completes without any errors; and responsive to a determination indicating a successful execution, recording an updated data set generated by execution of the upgrade specification; or responsive to a determination not indicating a successful execution, causing execution of the safest specification, and recording an updated data set generated by execution of the safest specification.

Clause 2. The computer-implemented method of Clause 1, wherein the set of safest runtime parameters comprises one or more runtime parameters from previous successfully executed sets of runtime parameters associated with the data processing workflow.

Clause 3. The computer-implemented method of Clause 1, wherein the set of safest runtime parameters is the same as the first set of runtime parameters.

Clause 4. The computer-implemented method of Clause 1, wherein each set of runtime parameters is unique to a job, wherein the job is representative of an executable task that is performed when executing the data processing workflow, and wherein the job is configured to generate one or more sets of output data based at least on one or more sets of input data.

Clause 5. The computer-implemented method of Clause 4, wherein a plurality of jobs are associated with performing the data processing workflow.

Clause 6. The computer-implemented method of any of Clauses 1-5, wherein each set of runtime parameters includes information representative of one or more of: input data configurations, output data configurations, a job name, a job type, a job version, an execution environment, and a runtime dependency.

Clause 7. The computer-implemented method of Clause 6, wherein the input data configurations comprise one or more of: input data, input data source, data schema, and data formatting associated with input data that is to be processed via execution of one or more jobs.

Clause 8. The computer-implemented method of any of Clauses 6-7, wherein the output data configurations comprise one or more of: storage location, data schema, data formatting, data compression, data partitioning, and data overwrite behavior associated with output data generated via execution of one or more jobs.

Clause 9. The computer-implemented method of any of Clauses 6-8, wherein the execution environment comprises one or more software applications.

Clause 10. The computer-implemented method of any of Clauses 6-9, wherein the runtime dependency comprises executable code and/or libraries useable for processing at least one or more sets of input data.

Clause 11. The computer-implemented method of any of Clauses 6-10, wherein the execution environment is configured to execute the executable code of the runtime dependency.

Clause 12. The computer-implemented method of any of Clauses 1-11, wherein causing execution of the upgrade specification comprises: retrieving or loading a runtime dependency associated with the set of upgrade runtime parameters; and causing execution of an executable of the runtime dependency in an execution environment associated with the set of upgrade runtime parameters.

Clause 13. The computer-implemented method of Clause 12, wherein causing execution of the executable of the runtime dependency associated with the set of upgrade runtime parameters comprises: generating one or more sets of output data based at least on (i) input data configurations associated with the set of upgrade runtime parameters and (ii) output data configurations associated with the set of upgrade runtime parameters.

Clause 14. The computer-implemented method of any of Clauses 1-11, wherein causing execution of the safest specification comprises: retrieving or loading a runtime dependency associated with the set of safest runtime parameters; and executing an executable of the runtime dependency in an execution environment associated with the set of safest runtime parameters.

Clause 15. The computer-implemented method of Clause 14, wherein executing the executable of the runtime dependency associated with the set of safest runtime parameters comprises: generating one or more sets of output data based at least on (i) input data configurations associated with the set of safest runtime parameters and (ii) output data configurations associated with the set of safest runtime parameters

Clause 16. The computer-implemented method of Clause 1, wherein each set of rules comprises information representative of one or more of: execution conditions associated with a respective specification, and execution constraints associated with a respective specification.

Clause 17. The computer-implemented method of Clause 16, wherein the set of upgrade specification rules comprises one or more of: a determination of whether the first set of runtime parameters satisfy an upgrade threshold, a determination of upgrade availability, and a determination of whether one or more of the upgrade runtime parameters have previously failed to execute.

Clause 18. The computer-implemented method of Clause 16, wherein the set of safest specification rules comprises one or more of: a determination of whether one or more of the first set of runtime parameters are blacklisted, and a determination of whether the first set of runtime parameters has been previously executed.

Clause 19. The computer-implemented method of Clause 1, wherein each rule in a set of rules is associated with a runtime parameter in a set of runtime parameters.

Clause 20. The computer-implemented method of Claim 19, wherein each rule is configured to update only the runtime parameter with which the respective rule is associated.

Clause 21. The computer-implemented method of Clause 20, the method further comprising: determining that a rule has updated a runtime parameter that is not associated with the respective rule; generating an alert or notification indicative of the runtime parameter being improperly updated; and causing presentation, to a user, of visual indicia associated with the alert or notification in an interactive graphical user interface (GUI) of a software application.

Clause 22. The computer-implemented method of Clause 1, wherein the rules are defined by a developer of a computing system configured to execute the data processing workflow.

Clause 23. The computer-implemented method of Clause 1, wherein the rules are defined by a user of a computing system configured to execute the data processing workflow.

Clause 24. The computer-implemented method of any of Clauses 1-5, wherein execution of the upgrade specification is successful if a job associated with the set of upgrade runtime parameters completes without errors.

Clause 25. The computer-implemented method of Clause 1, wherein causing execution of the upgrade specification is performed automatically without requiring additional user activity.

Clause 26. The computer-implemented method of Clause 1, wherein causing execution of the safest specification is performed automatically without requiring additional user activity.

Clause 27. The computer-implemented method of Clause 1, the method further comprising: generating a recommendation to execute the upgrade specification; and causing presentation, to a user, of a graphical element in an interactive GUI of a software application, wherein the graphical element is representative of the recommendation.

Clause 28. The computer-implemented method of Clause 27, the method further comprising: receiving, via the software application, a selection of the graphical element; and responsive to the selection, causing execution of the upgrade specification.

Clause 29. The computer-implemented method of Clause 1, the method further comprising: generating a recommendation to execute the safest specification; and causing presentation, to a user, of a graphical element in an interactive GUI of a software application, wherein the graphical element is representative of the recommendation.

Clause 30. The computer-implemented method of Clause 29, the method further comprising: receiving, via the software application, a selection of the graphical element; and responsive to the selection, causing execution of the safest specification.

Clause 31. The computer-implemented method of Clause 1, the method further comprising: causing presentation of one or more graphical elements in an interactive GUI of a software application, wherein the one or more graphical elements are representative of the set of upgrade runtime parameters and/or of the set of upgrade specification rules.

Clause 32. The computer-implemented method of Clause 1, the method further comprising: causing presentation of one or more graphical elements in an interactive GUI of a software application, wherein the one or more graphical elements are representative of the set of safest runtime parameters and/or of the set of safest specification rules.

Clause 33. The computer-implemented method of Clause 1, the method further comprising: responsive to the determination not indicating the successful execution of the upgrade specification, generating an alert or notification indicative of failed execution; and causing presentation, to a user, of one or more graphical elements associated with the alert or notification in an interactive GUI of a software application.

Clause 34. The computer-implemented method of Clause 1, the method further comprising: responsive to the determination indicating the successful execution of the upgrade specification, generating an alert or notification indicative of the successful execution; and causing presentation, to a user, of one or more graphical elements associated with the alert or notification in an interactive GUI of a software application.

Clause 35. A system comprising: one or more computer-readable storage mediums or devices comprising, configured to store, and/or storing program instructions; and one or more processors configured to execute the program instructions to cause the system to perform the computer-implemented method of any of Clauses 1-34.

Clause 36. One or more computer-readable storage mediums or devices comprising, configured to store, and/or storing program instructions, the program instructions executable by one or more processors to cause the one or more processors to perform the computer-implemented method of any of Clauses 1-34.

What is claimed is:

1. A computer-implemented method for adjudicating updates to one or more runtime parameters associated with a data processing workflow, the computer-implemented method comprising, by one or more processors executing program instructions:
receiving or accessing a first specification, wherein the first specification comprises information indicative of a first set of runtime parameters associated with a data processing workflow to be applied to a dataset;
generating an upgrade specification based at least on the first specification and a set of upgrade specification rules, wherein the upgrade specification comprises information indicative of a set of upgrade runtime parameters associated with the data processing workflow, wherein the set of upgrade runtime parameters comprises one or more runtime parameters that are updated from the first set of runtime parameters, and wherein the set of upgrade specification rules is configured to cause updates to certain of the first set of runtime parameters to obtain the set of upgrade runtime parameters;
generating a safest specification based at least on the first specification and a set of safest specification rules, wherein the safest specification comprises information indicative of a set of safest runtime parameters associated with the data processing workflow, wherein the set of safest runtime parameters comprises one or more runtime parameters from the first set of runtime parameters, wherein the set of safest specification rules is associated with historical data indicative of previously successful executions of the data processing workflow, and wherein the set of safest runtime parameters is different from the set of upgrade runtime parameters;
causing execution of the upgrade specification;
determining whether the execution of the upgrade specification is successful, wherein the execution is successful if the execution completes without any errors; and
responsive to a determination indicating a successful execution, recording an updated data set generated by execution of the upgrade specification; or
responsive to a determination not indicating a successful execution, causing execution of the safest specification, and recording an updated data set generated by execution of the safest specification.

2. The computer-implemented method of claim 1, wherein the set of safest runtime parameters comprises one or more runtime parameters from previous successfully executed sets of runtime parameters associated with the data processing workflow.

3. The computer-implemented method of claim 1, wherein the set of safest runtime parameters is the same as the first set of runtime parameters.

4. The computer-implemented method of claim 1, wherein each set of runtime parameters is unique to a job, wherein the job is representative of an executable task that is performed when executing the data processing workflow, and wherein the job is configured to generate one or more sets of output data based at least on one or more sets of input data.

5. The computer-implemented method of claim 4, wherein a plurality of jobs are associated with performing the data processing workflow.

6. The computer-implemented method of any of Claims claim 4, wherein each set of runtime parameters includes information representative of one or more of: input data configurations, output data configurations, a job name, a job type, a job version, an execution environment, and a runtime dependency.

7. The computer-implemented method of claim 6, wherein the input data configurations comprise one or more of: input data, input data source, data schema, and data formatting associated with input data that is to be processed via execution of one or more jobs.

8. The computer-implemented method of claim 6, wherein the output data configurations comprise one or more of: storage location, data schema, data formatting, data compression, data partitioning, and data overwrite behavior associated with output data generated via execution of one or more jobs.

9. The computer-implemented method of claim 6, wherein the execution environment comprises one or more software applications.

10. The computer-implemented method of claim 6, wherein the runtime dependency comprises executable code and/or libraries useable for processing at least one or more sets of input data.

11. The computer-implemented method of Claims claim 10, wherein the execution environment is configured to execute the executable code of the runtime dependency.

12. The computer-implemented method of any of Claims claim 1, wherein causing execution of the upgrade specification comprises:
retrieving or loading a runtime dependency associated with the set of upgrade runtime parameters; and
causing execution of an executable of the runtime dependency in an execution environment associated with the set of upgrade runtime parameters.

13. The computer-implemented method of claim 12, wherein causing execution of the executable of the runtime dependency associated with the set of upgrade runtime parameters comprises:
generating one or more sets of output data based at least on (i) input data configurations associated with the set of upgrade runtime parameters and (ii) output data configurations associated with the set of upgrade runtime parameters.

14. The computer-implemented method of claim 1, wherein causing execution of the safest specification comprises:
retrieving or loading a runtime dependency associated with the set of safest runtime parameters; and
executing an executable of the runtime dependency in an execution environment associated with the set of safest runtime parameters.

15. The computer-implemented method of claim 14, wherein executing the executable of the runtime dependency associated with the set of safest runtime parameters comprises:
generating one or more sets of output data based at least on (i) input data configurations associated with the set of safest runtime parameters and (ii) output data configurations associated with the set of safest runtime parameters.

16. The computer-implemented method of claim 1, wherein each set of rules comprises information representative of one or more of: execution conditions associated with a respective specification, and execution constraints associated with a respective specification.

17. The computer-implemented method of claim 16, wherein the set of upgrade specification rules comprises one or more of:
a determination of whether the first set of runtime parameters satisfy an upgrade threshold,
a determination of upgrade availability, and
a determination of whether one or more of the upgrade runtime parameters have previously failed to execute.

18. The computer-implemented method of claim 16, wherein the set of safest specification rules comprises one or more of:
a determination of whether one or more of the first set of runtime parameters are blacklisted, and
a determination of whether the first set of runtime parameters has been previously executed.

19. A system comprising:
one or more computer-readable storage mediums or devices comprising, configured to store, and/or storing program instructions; and
one or more processors configured to execute the program instructions to cause the system to perform the computer-implemented method of claim 1.

20. One or more computer-readable storage mediums or devices comprising, configured to store, and/or storing program instructions, the program instructions executable by one or more processors to cause the one or more processors to perform the computer-implemented method of claim 1.
